(19) United States
(12) Patent Application Publication
(10) Pub. No.: US 2018/0217906 A1
(43) Pub. Date: Aug. 2, 2018

(54) Method For Optimizing Reconstruction Of Data For A Hybrid Object Storage Device

(71) Applicant: AGENCY FOR SCIENCE, TECHNOLOGY AND RESEARCH, Singapore (SG)

(72) Inventors: Chao JIN, Singapore (SG); Khai Leong YONG, Singapore (SG); Weiya XI, Singapore (SG)

(21) Appl. No.: 15/506,096

(22) PCT Filed: Sep. 30, 2015
(86) PCT No.: PCT/SG2015/050355

§ 371 Date: Feb. 23, 2017

(30) Foreign Application Priority Data
Oct. 3, 2014 (SG) 10201406331V

(51) Int. Cl. G06F 11/20; G06F 3/06

(52) U.S. Cl. CPC G06F 11/2094; G06F 3/0604; G06F 2201/82; G06F 3/0659; G06F 3/067; G06F 3/0619

(57) ABSTRACT

A method for data reconstruction when one HOSD has failed in a cluster of Hybrid Object Storage Devices (HOSDs) is disclosed. The method includes receiving one of a read request and a write request from a server to access data from a failed one of the plurality of storage devices and reconstructing the requested data stored in the failed one of the plurality of storage devices from portions of data stored in one or more available ones of the plurality of storage devices. The method also includes sending the requested data from the reconstructed data back to the server and sending the reconstructed data to a replacement one of the plurality of storage devices. Finally, the method includes updating a reconstruction list to indicate the replacement one of the plurality of storage devices and completion of data reconstruction.

### PRIORITY CLAIM

This application claims priority from Singapore Patent Application No. 10201406331V filed on Oct. 3, 2014.

### FIELD OF THE INVENTION

The present invention relates to a storage system and, more specifically, relates to data reconstruction within such a storage system.

### BACKGROUND TO THE INVENTION

Ideally data reconstruction of data in a failed data storage device in a data storage system occurs as offline reconstruction in which the storage system stops replying to any client/application server in order to allow the data reconstruction process to run at full speed. However, this scenario is not practical in most production environments as most storage systems are required to provide uninterrupted data services even when they are recovering from disk failures.

Thus, what is needed is a method and device for data reconstruction which at least partially overcomes the drawbacks of present approaches by providing uninterrupted data services while recovering from disk failures. Furthermore, other desirable features and characteristics will become apparent from the subsequent detailed description and the appended claims, taken in conjunction with the accompanying drawings and this background of the disclosure.

### SUMMARY OF INVENTION

In one aspect of the invention, a method for data reconstruction in a data storage system comprising a plurality of storage devices is provided. The method includes receiving one of a read request and a write request from a server to access data from a failed one of the plurality of storage devices and reconstructing the requested data stored in the failed one of the plurality of storage devices from portions of data stored in one or more available ones of the plurality of storage devices. The method further includes sending the requested data from the reconstructed data back to the server and sending the reconstructed data to a replacement one of the plurality of storage devices. Finally, the method includes updating a reconstruction list to indicate the replacement one of the plurality of storage devices and completion of data reconstruction.

In an additional aspect of the invention, a method for data reconstruction in a cluster of Hybrid Object Storage Devices (HOSDs) when one HOSD has failed wherein the cluster of HOSDs includes a primary HOSD is provided. The method includes identifying data in the failed HOSD which is available in non-volatile memory of the primary HOSD, copying the identified data available in the non-volatile memory of the primary HOSD to a replacement HOSD, and updating a reconstruction list in the primary HOSD to indicate the replacement HOSD and completion of data reconstruction.

In yet an additional aspect of the invention, a method for data reconstruction in a cluster of Hybrid Object Storage Devices (HOSDs) when one HOSD has failed is provided. The method includes computing data in the failed HOSD based on data available in a non-volatile memory of a primary HOSD, writing the computed data to a replacement HOSD, and updating a reconstruction list to indicate the replacement HOSD and completion of data reconstruction

In a further aspect of the present invention, a data storage system including an Erasure Code Group (ECG) cluster of Hybrid Object Storage Devices (HOSDs) is disclosed. One of the ECG cluster of HOSDs is assigned as a primary HOSD. The primary HOSD includes a non-volatile (NV) cache, a reconstruction list, a reconstruction processor and one or more communication interfaces. The NV cache includes a local cache which stores object data from the primary HOSD. The reconstruction list indicates a status of failed HOSD reconstruction. The reconstruction processor is coupled to the NV cache and the reconstruction list, the reconstruction processor reconstructing failed HOSD data and updating the status of the failed HOSD reconstruction in the reconstruction list. The one or more communication interfaces is coupled to the reconstruction processor for communicating with a client/application server and for communicating with other HOSDs in the cluster of HOSDs

### BRIEF DESCRIPTION OF THE DRAWINGS

The accompanying figures, where like reference numerals refer to identical or functionally similar elements throughout the separate views and which together with the detailed description below are incorporated in and form part of the specification and serve to illustrate various embodiments and to explain various principles and advantages in accordance with a present invention, by way of non-limiting example only.

FIG. 1 illustrates a diagram of a data storage system in accordance with a present embodiment where the data storage system includes a plurality of Hybrid Object Storage Devices (HOSD), one HOSD being assigned as a HOSD primary storage device and another HOSD having failed.

FIG. 2 illustrates a diagram of the data storage system of FIG. 1 including an Erasure Code Group (ECG) in accordance with the present embodiment.

FIG. 3 illustrates a diagram of the ECG of FIG. 2 wherein the HOSD store at least a representation of their object data in the HOSD primary storage device of the ECG in accordance with the present embodiment.

FIG. 4 illustrates a block diagram of the HOSD primary storage device of the data storage system of FIG. 3 in accordance with the present embodiment.

FIG. 5 illustrates a flow chart of the HOSD primary storage device of FIG. 2 in accordance with the present embodiment.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of this invention to present a system and methods for data reconstruction which provides uninterrupted data services while recovering from disk failures.

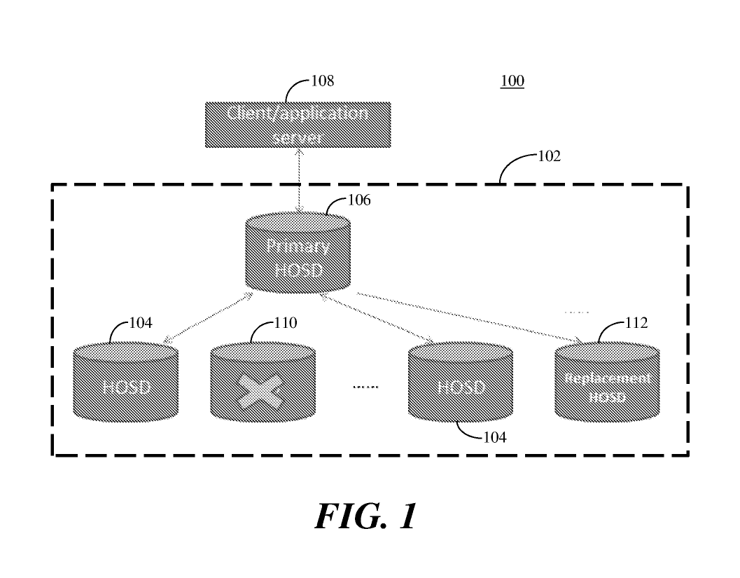

Referring to FIG. 1, a diagram 100 of a data storage system in accordance with a present embodiment is disclosed. The data storage system 102 includes a plurality of Hybrid Object Storage Devices (HOSD) 104, one HOSD being assigned as a HOSD primary storage device 106. The data storage system 102 is coupled to a server 108 (either a client server or an application server). Reconstruction optimization in accordance with the present embodiment occurs when one HOSD 110 fails.

Once a HOSD failure is identified, the primary HOSD 106 begins the reconstruction process. If there is a read request or a write request from the client/application server 108 to access data from the failed HOSD 110 during reconstruction, the data will be reconstructed by the primary HOSD 106 by computing data read out from other available HOSDs 104. The reconstructed data is then sent back to the client/application server 108 from the primary HOSD 106. The primary HOSD 106 can also send the data to a replacement HOSD 112 and update a reconstruction list maintained by the primary HOSD 106 to indicate that the data has been reconstructed.

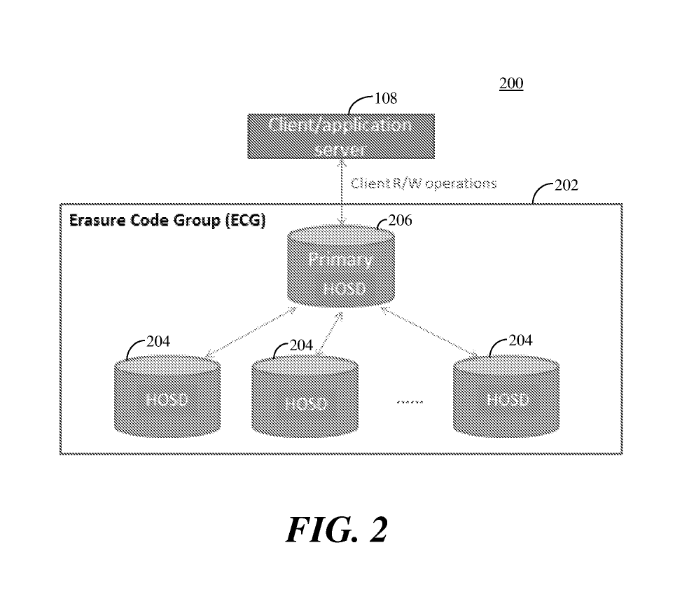

Referring to FIG. 2, a diagram 200 depicts an active drive cluster of the data storage system 102 (FIG. 1) which includes multiple Erasure Code Hybrid Object Storage Device (HOSD) Groups (ECG) 202 in accordance with the present embodiment. Each ECG 202 contains multiple normal HOSDs 204 and one primary HOSD 206. When there is a request from the client/application server 108, the request will be directed to the primary HOSD 206. The primary HOSD 206 retrieves the requested data from the other HOSDs 204, and then forwards the requested data back to the server 108. When there is a HOSD failure, the primary HOSD 206 will be the one which starts the reconstruction process, keeps an object list, track the reconstruction process, compute the reconstructed data, send the reconstructed data to a replacement HOSD, and maintain a reconstruction list.

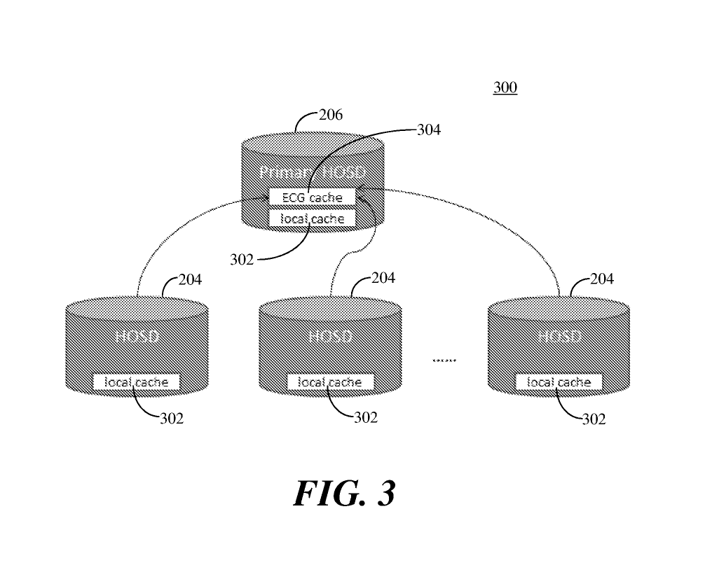

Referring to FIG. 3, a diagram 300 depicts the HOSD 204 storing at least a representation of their object data in the HOSD primary storage device 206 of the ECG in accordance with the present embodiment. Each HOSD 204, including the primary HOSD 206, includes a local cache 302 for storing at least a representation of locally stored object data. A Non-Volatile (NV) cache in the primary HOSD 206 has two portions of data. One portion of the NV cache is the local cache 302 which stores the object data from the primary HOSD 206. The other portion of the NV cache is an ECG cache 304 which caches at least a representation of the object data from the local caches 302 of the other HOSDs 204 within the same ECG. Both the ECG cache 304 and the local cache 302 provide improved system performance. In addition, the reconstruction process can be optimized based on data in the ECG cache 304.

In accordance with a first optimized reconstruction process, data in the ECG cache 304 is reconstructed when one of the HOSDs 204 in the ECG fails. The primary HOSD 206 reconstructs the data of the failed HOSD 204 in the ECG cache 304 with a high priority. The data reconstruction can be done either by directly copying the data available in the ECG cache 304 to a replacement HOSD or compute the data based on available data in the ECG cache 304 and then writing the computed data to the replacement HOSD. The primary HOSD 206 can then update the reconstruction list.

In accordance with a second optimized reconstruction process, data requested by the client/application server 108 includes data from a failed HOSD 204 in the ECG. If the read/write request from client/application server 108 to access the data from the failed HOSD is received during reconstruction, the data being accessed will be reconstructed on the fly with a high priority by computing data read out from other available HOSDs 204, and then sending the computed data back to the client/application server 108. In the meantime, the primary HOSD 206 will also send the data to a replacement HOSD and update the reconstruction list in the primary HOSD 206 to indicate that the object data has been reconstructed.

In accordance with a normal reconstruction process, the primary HOSD 206 reconstructs the data by reading data from other available HOSDs 204 and recomputing the read data to recover the data. Once completed, the primary HOSD 206 will write the recomputed data to a replacement HOSD and update the reconstruction list.

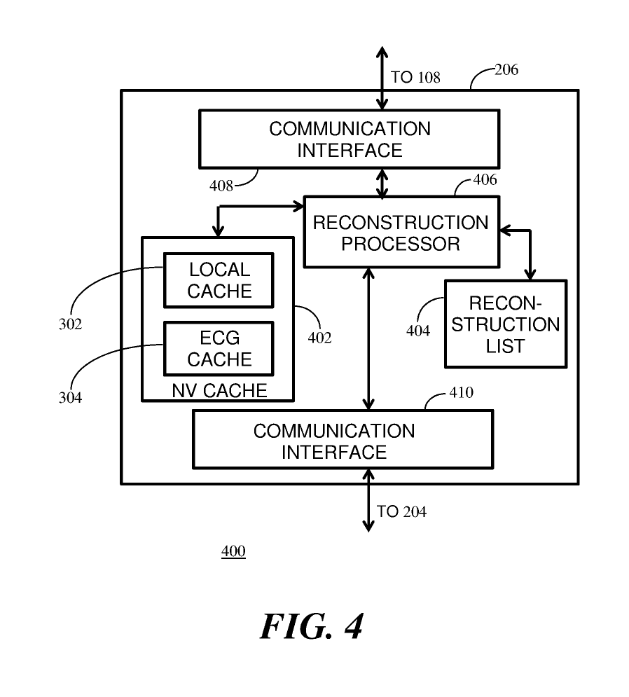

Referring to FIG. 4, a block diagram 400 depicts the HOSD primary storage device 206 of the ECG 202 (FIG. 2) of the data storage system 102 (FIG. 1) in accordance with the present embodiment. The primary HOSD 206 includes a non-volatile (NV) cache 402 which includes the local cache 302 for storing object data from the primary HOSD 206 and the ECG cache 304 for storing object data from the other HOSDs 204 in the ECG 202.

A reconstruction list 404 indicates a status of failed HOSD reconstruction. A reconstruction processor 406 is coupled to the NV cache 402 and the reconstruction list and reconstructs failed HOSD data as well as updates the status of the failed HOSD reconstruction in the reconstruction list 404. A first communication interface 408 couples the reconstruction processor 406 to client/application server 108 for communication therewith and a second communication interface 408 couples the reconstruction processor 406 to the other HOSDs 204 in the ECG 202 for writing data to or reading data from the HOSDs 204 and for retrieving local cache data from the HOSDs 204 for storing into the ECG cache 304. The reconstruction processor 406 also communicates with the HOSDs 204 via the second communication interface to detect when one of the HOSDs 204 fails and to assign an available HOSD 204 as a replacement HOSD.

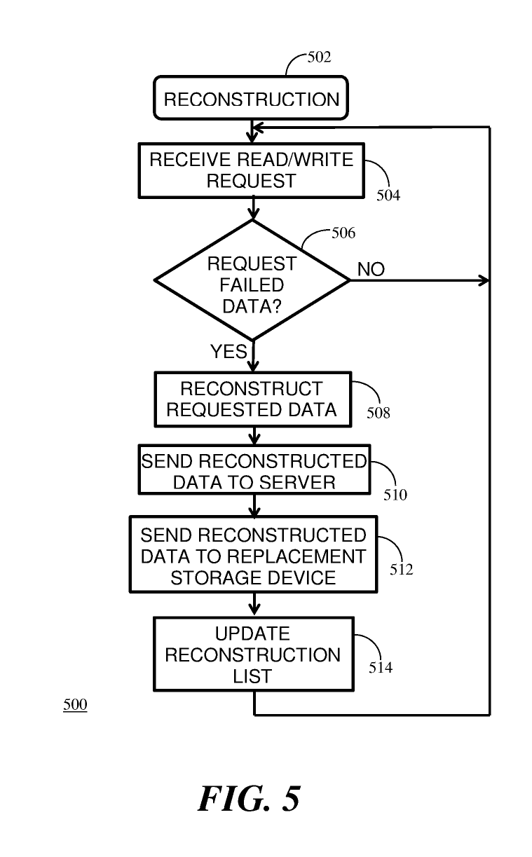

Referring to FIG. 5, a flow chart 500 depicts the optimized reconstruction process 502 of the reconstruction processor 406 in accordance with the present embodiment. If a read request or a write request is received 504 from the client/application server 108 during reconstruction, the reconstruction processor 406 determines 506 whether the read/write requests is requesting failed data. If the reconstruction processor 406 determines 506 that the read/write request is not requesting failed data, normal reconstruction processing continues until another read/write request is received 504.

When the reconstruction processor 406 determines 506 that the read/write request is requesting failed data, reconstruction of the requested data is prioritized so that the requested data is immediately reconstructed 508 and, once reconstructed 508, is sent 510 to the client/application server 108. In this manner, uninterrupted data services with the client/application server 108 can be conducted by the primary HOSD 206 even while the ECG 202 is recovering from a disk failure. As discussed above, the requested data can be reconstructed from object data in the ECG cache 304 or from data in the HOSDs 204.

After the requested data is sent 510 to the client/application server 108, it is then sent 512 to a replacement storage device, the replacement storage device being one of the HOSDs 204 assigned as a replacement storage device by the reconstruction processor 406. The reconstruction processor 406 then updates 514 the reconstruction list 404 to indicate the replacement one of the HOSDs 204. Normal reconstruction processing continues until either another read/write request is received 504 or processing is completed. When all reconstruction is complete, the reconstruction processor 406 updates the reconstruction list 404 to indicate the completion of data reconstruction.

Thus, it can be seen that the present embodiment can provide optimized uninterrupted data services even while recovering from disk failures. In addition, it provides advantageous methods for reconstruction of failed disks from either an Erasure Code Group (ECG) cache in a primary Hybrid Object Storage Device (HOSD) within the ECG or from one or more other HOSD in the ECG. While exemplary embodiments have been presented in the foregoing detailed description of the invention, it should be appreciated that a vast number of variations exist.

It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of elements and method of operation described in an exemplary embodiment without departing from the scope of the invention as set forth in the appended claims.

1. A method for data reconstruction in a distributed object data storage system comprising a plurality of Hybrid Object Storage Devices (HOSDs), the method comprising:
receiving one of a read request and a write request from a server to access data from a failed one of the plurality of HOSDs;
requesting object data stored in the failed one of the plurality of HOSDs from portions of object data stored in one or more available ones of the plurality of HOSDs;
reconstructing only object data in the failed one of the plurality of HOSDs from the portions of object data requested from the one or more available ones of the plurality of HOSDs;
sending the requested data from the reconstructed data back to the server;
after sending the requested data to the server, sending the reconstructed data to a replacement one of the plurality of HOSDs; and
updating a reconstruction list to indicate the replacement one of the plurality of HOSDs and completion of data reconstruction, wherein a HOSD of the plurality of HOSDs is assigned as a HOSD primary storage device and wherein one or more of the reconstructing step, the sending the reconstructed data step and the updating step are performed within the HOSD primary storage device.

2.-5. (canceled)

6. The method of claim 1, wherein the receiving step comprises receiving one of the read request and the write request from a client server to access the data from the failed one of the plurality of storage devices.

7. The method of claim 1, wherein the receiving step comprises receiving one of the read request and the write request from an application server to access the data from the failed one of the plurality of storage devices.

8. A method for data reconstruction without interrupting communication in a cluster of Hybrid Object Storage Devices (HOSDs) when one HOSD has failed wherein the cluster of HOSDs includes a primary HOSD, the method comprising:
receiving one of a read request and a write request from a server to access data from the failed one of the plurality of HOSDs;
identifying the requested data from the failed HOSD which is available in non-volatile memory of the primary HOSD;
sending the requested data from the identified data in the non-volatile memory of the primary HOSD back to the server;
after sending the requested data to the server, reconstructing the data of the failed one of the plurality of HOSDs from the identified data in the non-volatile memory of the primary HOSD;
writing the reconstructed data to a replacement HOSD; and
updating a reconstruction list in the primary HOSD to indicate the replacement HOSD and completion of data reconstruction.

9. A method for data reconstruction without interrupting communication in a cluster of Hybrid Object Storage Devices (HOSDs) when a hard disk drive (HDD) of one HOSD has failed, the method comprising:
receiving one of a read request and a write request from a server to access data from the failed HDD;
identifying the requested data from the failed HDD which is available in non-volatile memory of the HOSD comprising the failed HDD;
sending the identified data from the non-volatile memory of the HOSD comprising the failed HDD back to the server;
reconstructing data of the failed HDD based on data available in a non-volatile memory of the HOSD comprising the failed HDD;
writing the reconstructed data to a replacement HOSD; and
updating a reconstruction list to indicate the replacement HOSD and completion of data reconstruction.

10. A data storage system comprising an Erasure Code Group (ECG) cluster of Hybrid Object Storage Devices (HOSDs) and one of the ECG cluster of HOSDs being assigned as a primary HOSD, the primary HOSD comprising:
a non-volatile (NV) cache including a local cache and an ECG cache, wherein the local cache stores object data from the primary HOSD and the ECG cache stores object data from other HOSDs within the ECG cluster of HOSDs;
a reconstruction list for indicating status of failed HOSD reconstruction;
a reconstruction processor coupled to the NV cache and the reconstruction list, the reconstruction processor reconstructing at least a first portion of failed HOSD data from the object data stored in the ECG cache in response to a request for data in a failed HOSD, the reconstruction processor further updating the status of the failed HOSD reconstruction in the reconstruction list; and
one or more communication interfaces coupled to the reconstruction processor for communicating with a client/application server for receiving the request for data from HOSDs in the ECG cluster and for communicating with other HOSDs in the ECG cluster of HOSDs.

11. The data storage system of claim 10 wherein the reconstruction processor of the primary HOSD further reconstructs at least a second portion of the failed HOSD data from a local cache stored in a NV cache of the failed HOSD when only a hard disk drive (HDD) in the failed HOSD fails.

12. The data storage system of claim 11 wherein the reconstruction processor of the primary HOSD further identifies an available one of the ECG cluster of HOSDs as a replacement HOSD, the reconstruction processor further copying at least the first and second reconstructed portions of the failed HOSD data to the replacement HOSD.

13. The data storage system of claim 10, wherein the reconstruction processor of the primary HOSD further identifies an available one of the ECG cluster of HOSDs as a replacement HOSD, the reconstruction processor further copying at least the first reconstructed portions of the failed HOSD data to the replacement HOSD.

14. (canceled)

15. The data storage system of claim 13, wherein the reconstruction processor forwards the at least first reconstructed portion of failed HOSD data to the one or more communication interfaces for communicating to the client/application server requesting the data in the failed HOSD before copying at least the first reconstructed portions of the failed HOSD data to the replacement HOSD.

16. The data storage system of claim 13, wherein the reconstruction processor forwards the at least first reconstructed portion of failed HOSD data to the one or more communication interfaces for communicating to the client/application server requesting the data in the failed HOSD after copying at least the first reconstructed portions of the failed HOSD data to the replacement HOSD.

17. The method of claim 1, wherein all of the reconstructing step, the sending the reconstructed data step and the updating step are performed within the HOSD primary storage device.

18. The method of claim 1, wherein the failed one of the plurality of HOSDs comprises one or more failed hard disk drives (HDDs) and one or more non-volatile memory (NVM) devices, and wherein the one or more NVM devices comprise accessible cache memory, and wherein the reconstructing step comprises reconstructing only the object data at least partially from the accessible cache memory of the one of the one or more NVM devices.

19. The method of claim 1, wherein at least a portion of the plurality of HOSDs comprise an Erasure Code Group (ECG), and wherein the ECG comprises an ECG cache to cache objects from other HOSDs in the ECG, the ECG cache accessible by the HOSD primary storage device, and wherein the reconstructing step comprises the steps of:
identifying data in the failed HOSD which is available in the ECG cache; and
reconstructing at least a portion of the object data in the failed one of the plurality of HOSDs from the identified data available in the ECG cache.

20. The method of claim 8, wherein the one HOSD that has failed comprises a hard disk drive (HDD) which has failed and a non-volatile memory (NVM) device which has not failed, the method further comprising:
identifying the requested data from the failed HDD which is available in the NVM device of the HOSD comprising the failed HDD; and
sending the identified data from NVM device of the HOSD comprising the failed HDD back to the server, and wherein the reconstructing step comprises reconstructing the data of the failed HDD from identified data in the non-volatile memory of the primary HOSD and the identified data of available in the NVM device of the HOSD comprising the failed HDD.

21. The data storage system of claim 12, wherein the reconstruction list of the primary HOSD further indicates the replacement HOSD.

22. The data storage system of claim 13, wherein the reconstruction list of the primary HOSD further indicates the replacement HOSD.
